(19) United States
(12) Patent Application Publication
(10) Pub. No.: US 2026/0257719 A1
(43) Pub. Date: Sep. 3, 2026

(54) RECIRCULATING BALL STEERING APPARATUS

(71) Applicant: Ford Global Technologies, LLC, Dearborn, MI (US)

(72) Inventor: Joseph Washnock, Canton, MI (US)

(21) Appl. No.: 19/067,343

(22) Filed: Feb. 28, 2025

(51) Int. Cl. B62D 5/04

(52) U.S. Cl. CPC B62D 5/0448; B62D 5/0454

(57) ABSTRACT

Recirculating ball steering apparatus are disclosed. An example steering apparatus disclosed herein includes a worm gear, a ball nut positioned around a portion of the worm gear, a first gear fixed to the worm gear, a second gear fixed to a first pinion, the first pinion engaged with the first gear, the first pinion and the first gear to form a first bevel gear set, a motor fixed to a second pinion, the second pinion engaged with the second gear, the second pinion and the second gear to form a second bevel gear set, the motor to rotate the worm gear to translate the ball nut, and a sector gear engaged with the ball nut, the sector gear to rotate as the ball nut translates.

### FIELD OF THE DISCLOSURE

This disclosure relates generally to steering systems and, more particularly, to recirculating ball steering apparatus.

### BACKGROUND

Known vehicles typically include a mechanical linkage that connects front wheels of a vehicle to a steering wheel, which allows a driver to adjust the orientation of the front wheels by rotating the steering wheel. For example, many known steering systems include rack and pinion gears that translate rotational motion of a steering wheel to linear actuation or movement of a drag link and/or tie rods connected to the front wheels. As the steering wheel rotates, the drag link and/or the tie rods change the angular orientation of the wheels and steer the vehicle.

In recent years, trucks have utilized hydraulic assist recirculating ball (RCB) steering systems. The hydraulic assist of the RCB steering systems is provided by a pump that transports hydraulic steering fluid to the RCB system. In some implementations, electronic torque overlay mechanisms are utilized to provide an electric steering feel to the hydraulic system.

An example steering apparatus disclosed herein includes a worm gear, a ball nut positioned around a portion of the worm gear, a first gear fixed to the worm gear, a second gear fixed to a first pinion, the first pinion engaged with the first gear, the first pinion and the first gear to form a first bevel gear set, a motor fixed to a second pinion, the second pinion engaged with the second gear, the second pinion and the second gear to form a second bevel gear set, the motor to rotate the worm gear to translate the ball nut, and a sector gear engaged with the ball nut, the sector gear to rotate as the ball nut translates.

An example steering apparatus disclosed herein includes a worm gear, a ball nut positioned around a portion of the worm gear, a sector gear engaged with the ball nut, the sector gear aligned along a first rotational axis, a first gear fixed to the worm gear, a second gear engaged with the first gear, a third gear fixed to the second gear, the third gear and the second gear aligned along a second rotational axis, a position of the second rotational axis relative to the first rotational axis configurable to enable the second rotational axis to be substantially parallel to the first rotational axis, and a motor including a pinion engaged with the third gear.

An example vehicle steering system disclosed herein includes a worm gear, a ball nut positioned around a portion of the worm gear, the ball nut to translate as the worm gear rotates, at least two bevel gear sets including a first gear and a motor pinion, the first gear fixed to the worm gear, the at least two bevel gear sets to transfer rotation of the motor pinion to rotation of the worm gear, and a sector gear engaged with the ball nut, the sector gear to rotate as the ball nut translates.

### BRIEF DESCRIPTION OF THE DRAWINGS

FIG. 1 illustrates an example steering system in accordance with the teachings of this disclosure.

FIG. 2 illustrates a magnified view of a portion of the example steering system of FIG. 1.

FIG. 3 illustrates a magnified view of another portion of the example steering system of FIG. 1.

In general, the same reference numbers will be used throughout the drawing(s) and accompanying written description to refer to the same or like parts. The figures are not necessarily to scale.

### DETAILED DESCRIPTION

Traditionally, some heavy-duty trucks have utilized a steering mechanism including hydraulically assisted RCB gears or worm and wheel steering gears. In some instances, a pump provides the hydraulic assist to the RCB gears by pumping hydraulic steering fluid through the steering system. In some such instances, as the steering wheel is turned, a steering shaft rotates to cause a piston of the RCB gears to move linearly. In turn, the piston rotates a sector that is coupled to a pitman arm that turns the wheels. The hydraulic steering fluid is pumped to assist the movement of the piston based on the rotation of the steering shaft. However, hydraulic assist RCB gears lack precision in steering feel compared to electrically powered steering. Further, continuous pumping of a hydraulic pump causes a parasitic engine power loss and, thus, reduces an efficiency of the engine.

Known electrically powered steering systems utilize an electrically powered motor instead of the hydraulic pump and the associated piston to move a ball nut. However, the electrically powered steering systems often lack power compared to the hydraulic assist steering. As such, heavier vehicles, such as trucks and/or buses, typically utilize hydraulic assist steering.

Examples disclosed herein provide a torque assist gear train for an RCB steering system (e.g., steering apparatus, steering actuator, etc.) for vehicles. Advantageously, a configuration in which the torque assist gear train operates is versatile such that the RCB steering system is adaptable to different under-hood compartments of vehicles, which can have different space constraints for the steering system. Further, the torque assist gear train can provide a combined reduction of greater than 100:1 to generate ample force to turn wheels of heavier vehicles. Although examples disclosed herein may provide a gear reduction of greater than 100:1, the gear reduction may range anywhere from 1:1 to greater than 100:1. In some examples, the torque assist gear train provides a gear reduction of 35:1.

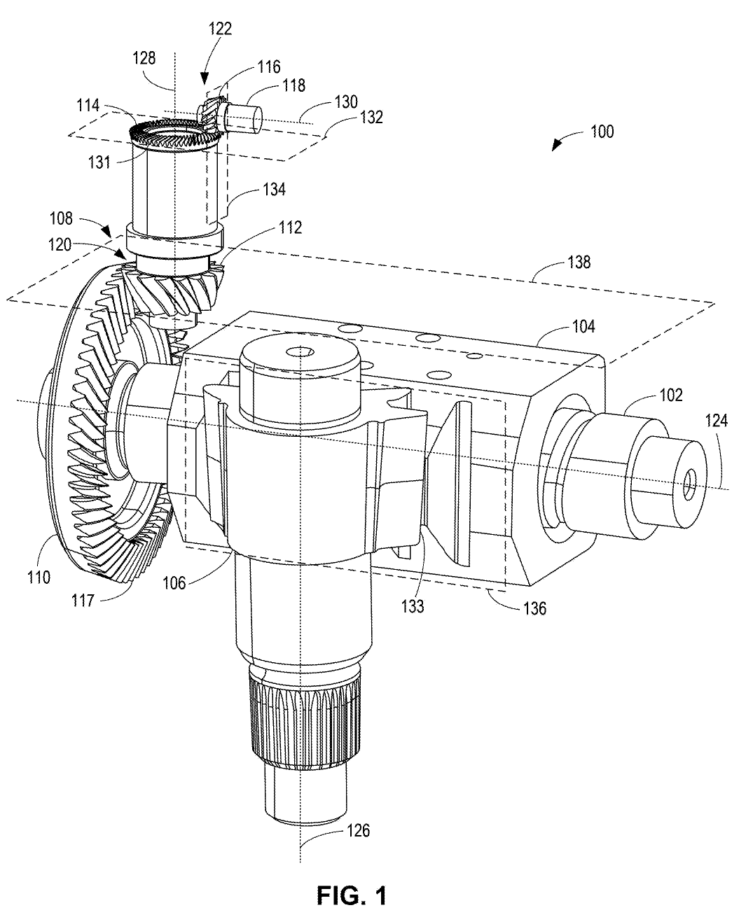

FIG. 1 illustrates an example steering system 100 in accordance with the teachings of this disclosure. The steering system 100 includes a worm gear 102, a ball nut 104, a sector gear 106, and a torque assist gear train 108. The worm gear 102 can be coupled to a steering wheel of a vehicle via a steering shaft. Accordingly, as the steering wheel rotates, the steering shaft rotates the worm gear 102. Further, the ball nut 104 translates as the worm gear 102 rotates. The ball nut 104 is engaged with the sector gear 106 such that the sector gear 106 rotates as the ball nut translates.

In the illustrated example of FIG. 1, the sector gear 106 includes splines to couple to a pitman arm. For example, the pitman arm can be operatively coupled to a drag link and, in turn, one or more tie rods. As a result, the pitman arm converts the rotation of the sector gear 106 to a movement of the drag link and the tie rod(s) to turn wheels of the vehicle. For example, the drag link and/or the tie rods are coupled to knuckles of the front wheels allowing the drag link and/or the tie rods to adjust the orientation of the front wheels as the pitman arm is moved by the sector gear 106.

The torque assist gear train 108 converts a rotational output of a motor to torque assistance for the steering system 100. The torque assist gear train 108 can help the steering system 100 generate enough force to steer heavier vehicles, such as trucks, while utilizing electrical power steering. The torque assist gear train 108 includes a first gear 110, a second gear 112 (e.g., a first pinion), a third gear 114, and a fourth gear 116 (e.g., a second pinion, a motor pinion).

The first gear 110 is fixed to the worm gear 102. As a result of being fixed to the worm gear 102, rotation of the steering wheel and, in turn, the steering shaft can rotate the first gear 110. In the example of FIG. 1, the first gear 110 is fixed to an end of the worm gear 102 opposite an end of the worm gear 102 that couples to the steering shaft. However, the first gear 110 can be fixed to a different location along a span of the worm gear 102 so long as the first gear 110 does not interfere with translation of the ball nut 104. In the illustrated example of FIG. 1, gear teeth 117 of the first gear 110 face (e.g., are oriented towards) the ball nut 104. In some examples, gear teeth of the first gear 110 face away from the ball nut 104. Accordingly, a position of the first gear 110 relative to the worm gear 102 is adjustable to accommodate an environment in which the steering system 100 is to be implemented.

Further, the second gear 112 is fixed to the third gear 114, and the fourth gear 116 is fixed to a shaft 118 of an electrical motor (not shown) . The first gear 110 is engaged with the second gear 112. The third gear 114 is engaged with the fourth gear 116. To help drive the rotation of the first gear 110 and, in turn, the worm gear 102, the motor can rotate the fourth gear 116, which rotates the third gear 114. In turn, the second gear 112, which rotates with the third gear 114, helps rotate the first gear 110. Thus, the torque from the torque assist gear train 108 relays torque from the motor to the worm gear 102. In some examples, during assisted driving operations, the steering torque can originate primarily or entirely from the motor.

Advantageously, the torque assist gear train 108 can provide a gear reduction of greater than 100:1. In this example, the torque assist gear train 108 provides a gear reduction of 35:1. In some examples, to provide additional torque assistance while reducing a size of the gears 110, 112, 114, 116, one or more intermediate gear sets can be positioned between the third gear 114 and the fourth gear 116. In such examples, the intermediate gear sets transfer rotation of the motor shaft 118 and the fourth gear 116 to the third gear 114, thereby causing the second gear 112 to drive the first gear 110.

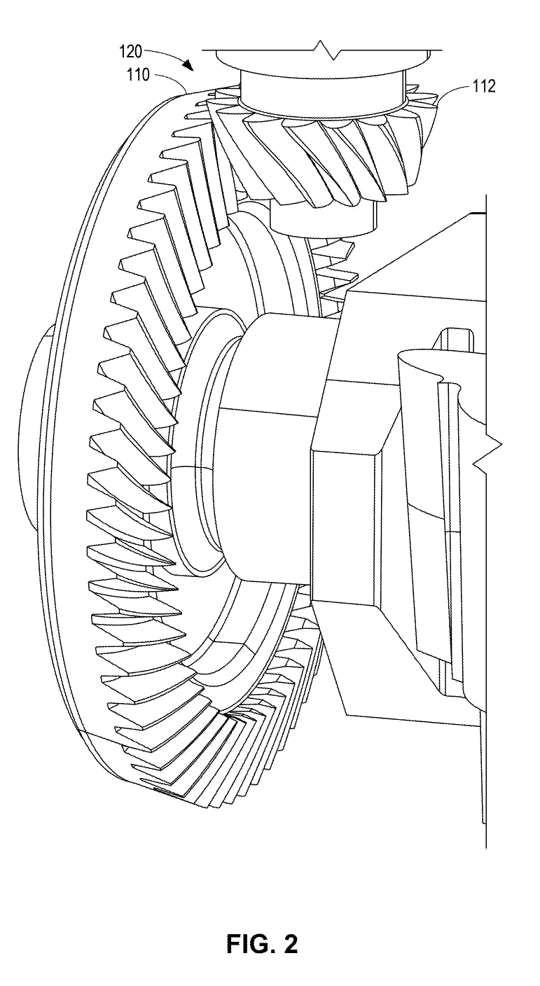

In the illustrated example of FIG. 1, the first gear 110 and the second gear 112 form a first bevel gear set 120. FIG. 2 illustrates a magnified view of the first bevel gear set 120. The gears 110, 112 of the first bevel gear set 120 can be straight bevel gears, spiral bevel gears, or hypoid gears depending on a desired gear reduction and an environment in which the steering system 100 is to be implemented (e.g., space availability in an under-hood compartment in which the steering system 100 is to be implemented).

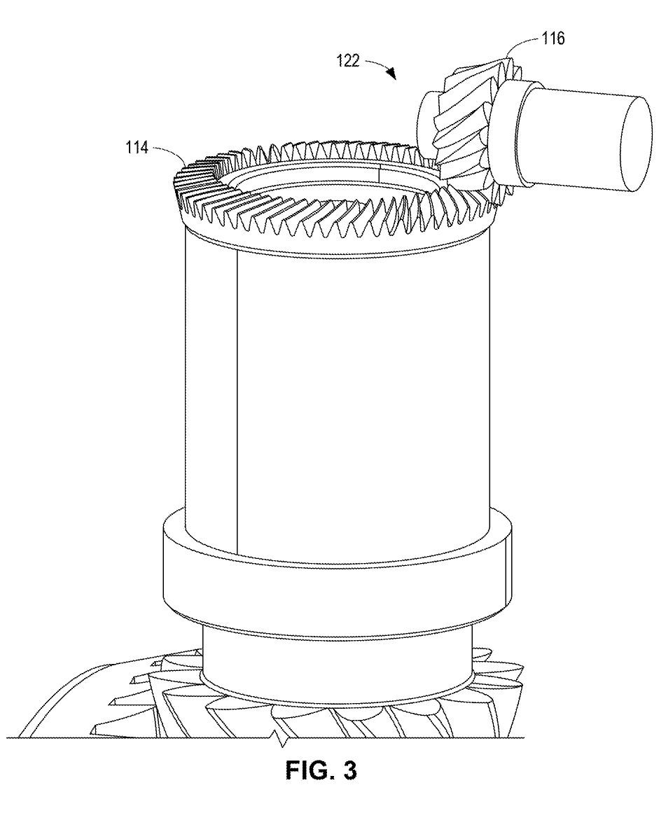

Similarly, the third gear 114 and the fourth gear 116 of FIG. 1 form a second bevel gear set 122. FIG. 3 illustrates a magnified view of the second bevel gear set 122. The gears 114, 116 of the second bevel gear set 122 can be straight bevel gears, spiral bevel gears, miter gears, or hypoid gears depending on the desired gear reduction and the environment in which the steering system 100 is to be implemented.

Returning to the illustrated example of FIG. 1, the worm gear 102 and the first gear 110 are aligned along a first rotational axis 124 (e.g., a first axis of rotation). The sector gear 106 is aligned along a second rotational axis 126 (e.g., a second axis of rotation). The second rotational axis 126 is substantially perpendicular to the first rotational axis 124. The second gear 112 and the third gear 114 are aligned along a third rotational axis 128 (e.g., a third axis of rotation). In the illustrated example of FIG. 1, the third rotational axis 128 is substantially perpendicular to the first rotational axis 124. The motor shaft 118 and the fourth gear 116 are aligned along a fourth rotational axis 130 (e.g., a fourth axis of rotation). In the illustrated example of FIG. 1, the fourth rotational axis 130 is substantially perpendicular to the third rotational axis 128.

Advantageously, relative positions of the gears 110, 112, 114, 116 in the torque assist gear train 108 can be adjusted based on the environment in which the steering system 100 is to be implemented. For example, the gear teeth 117 of the first gear 110 are distributed about a circumference of the first gear 110, and a position of the second gear 112 relative to the first gear 110 is adjustable to engage the gear teeth 117 at different locations about the circumference. Specifically, the position of the second gear 112 is configurable to engage the gear teeth 117 of the first gear 110 at every location about the circumference to enable the steering system 100 to adapt to different space constraints in different vehicles.

Accordingly, the third rotational axis 128 is able to be positioned in different locations that orbit the first rotational axis 124. In some examples, the third rotational axis 128 is substantially parallel to the second rotational axis 126. In some examples, the third rotational axis 128 is non-parallel to the second rotational axis 126. That is, a position of the third rotational axis 128 relative to the second rotational axis 126 is configurable to more than one orientation including a substantially parallel configuration and a non-parallel configuration. Thus, the location at which the second gear 112 engages the first gear 110 can be configured to (i) enable the third rotational axis 128 to be substantially parallel to the second rotational axis 126 and (ii) enable the third rotational axis 128 to be non-parallel to the second rotational axis 126.

Similarly, gear teeth 131 of the third gear 114 are distributed about a circumference of the third gear 114, and a position of the fourth gear 116 relative to the third gear 114 is adjustable to engage the gear teeth 131 of the third gear 114 at different locations about the circumference. Specifically, the position of the fourth gear 116 is configurable to engage the gear teeth 131 of the third gear 114 at every location about the circumference of the third gear 114 to enable the steering system 100 to adapt to different space constraints in different vehicles.

Accordingly, the fourth rotational axis 130 is able to be positioned in different locations that orbit the third rotational axis 128. Thus, a position of the fourth gear 116 relative to the third gear 114 is configurable to (i) align the fourth rotational axis 130 substantially parallel to the first rotational axis 124 and (ii) align the fourth rotational axis 130 substantially perpendicular to the first rotational axis 124 (e.g., from a viewpoint perpendicular to the second rotational axis 126). Further, a position of the fourth rotational axis 130 is movable to a substantially perpendicular position relative to the first rotational axis 124.

In the illustrated example of FIG. 1, the gear teeth 131 of the third gear 114 face away from the worm gear 102. Further, the gear teeth 131 of the third gear 114 are positioned along a first geometric plane 132 that does not intersect the worm gear 102. In this example, the engagement between the third gear 114 and the fourth gear 116 is aligned along a second geometric plane 134 normal to the fourth rotational axis 130. The second geometric plane 134 intersects the worm gear 102. In some examples, when the fourth gear 116 is positioned at a different location along the circumference of the third gear 114, the engagement between the third gear 114 and the fourth gear 116 is positioned along a different geometric plane that does not intersect the worm gear 102. Similarly, in some examples, when the gear teeth 117 of the first gear 110 face away from the ball nut 104, the engagement between the third gear 114 and the fourth gear 116 is able to be positioned along a different geometric plane that does not intersect the worm gear 102.

Further, an engagement between gear teeth 133 of the sector gear 106 and the ball nut 104 is aligned along a third geometric plane 136 that spans parallel to the first rotational axis 124 and the second rotational axis 126. Additionally, an engagement between the first gear 110 and the second gear is aligned along a fourth geometric plane 138 normal to the third rotational axis 128.

In some examples, the fourth geometric plane 138 is substantially perpendicular to the second geometric plane 134 and the third geometric plane 136. In some examples, because of the flexibility in the positioning of the second gear 112, the third gear 114, and the fourth gear 116, the third geometric plane 136 is configurable to be non-perpendicular to the second geometric plane 134 and/or the fourth geometric plane 138. Additionally, the steering system 100 is configurable to position the third geometric plane 136 substantially parallel to the fourth geometric plane 138 and substantially perpendicular to the second geometric plane 134. Further, the steering system 100 is configurable to position the third geometric plane 136 substantially perpendicular to the fourth geometric plane 138 and substantially parallel to the second geometric plane 134.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts. As used herein, when a first component (e.g., a first gear) is “fixed to” a second component (e.g., a second gear), the first component and the second component are fixedly coupled and rotate at a same rate.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a

As used herein in the context of describing the position and/or orientation of a first object, axis, or geometric plane relative to a second object, axis, or geometric plane, the term "substantially perpendicular" encompasses the term perpendicular and more broadly encompasses a meaning whereby the first object, axis, or geometric plane is positioned and/or oriented relative to the second object, axis, or geometric plane at an absolute angle of no more than ten degrees (10°) from perpendicular. For example, a first axis that is substantially perpendicular to a second axis is positioned and/or oriented relative to the second axis at an absolute angle of no more than ten degrees (10°) from perpendicular. Accordingly, as used herein, the term “non-perpendicular” encompasses a meaning whereby the first object, axis, or geometric plane is positioned and/or oriented relative to the second object, axis, or geometric plane at an absolute angle of more than ten degrees (10°) from perpendicular.

As used herein in the context of describing the position and/or orientation of a first object, axis, or geometric plane relative to a second object, axis, or geometric plane, the term "substantially parallel" encompasses the term parallel and more broadly encompasses a meaning whereby the first object, axis, or geometric plane is positioned and/or oriented relative to the second object, axis, or geometric plane at an absolute angle of no more than ten degrees (10°) from parallel. For example, a first axis that is substantially parallel to a second axis is positioned and/or oriented relative to the second axis at an absolute angle of no more than ten degrees (10°) from parallel. Accordingly, as used herein, the term “non-parallel” encompasses a meaning whereby the first object, axis, or geometric plane is positioned and/or oriented relative to the second object, axis, or geometric plane at an absolute angle of more than ten degrees (10°) from parallel.

From the foregoing, it will be appreciated that example systems, apparatus, and methods have been disclosed that provide motor-driven torque assistance to recirculating ball steering systems. Examples disclosed herein enable electrical steering assistance to generate sufficient torque to steer heavier vehicles. Additionally, examples disclosed herein provide torque assistance for recirculating ball steering that is configurable to fit within different under-hood environments. As such, examples disclosed herein are able to be utilized in a variety of vehicles that have different space constraints associated with the steering system to be implemented therein. Thus, the torque assistance and the positional flexibility of the example steering system disclosed herein enables the steering system to be suitable for use in different vehicles. Additionally, the positional flexibility of the example steering system disclosed herein can provide vehicle manufacturers with more flexibility in the positioning of other components in the under-hood compartment.

Recirculating ball steering apparatus are disclosed herein. Further examples and combinations thereof include the following:

Example 1 includes a steering apparatus comprising a worm gear, a ball nut positioned around a portion of the worm gear, a first gear fixed to the worm gear, a second gear fixed to a first pinion, the first pinion engaged with the first gear, the first pinion and the first gear to form a first bevel gear set, a second pinion fixed to a shaft of a motor, the second pinion engaged with the second gear, the second pinion and the second gear to form a second bevel gear set, the motor to rotate the worm gear to translate the ball nut, and a sector gear engaged with the ball nut, the sector gear to rotate as the ball nut translates.

Example 2 includes any preceding clause(s) of the steering apparatus of example 1, wherein the first gear and the worm gear are aligned along a first axis of rotation, wherein the motor and the second pinion are aligned along a second axis of rotation, wherein the position of the second pinion relative to the second gear is configurable to (i) align the second axis of rotation substantially parallel to the first axis of rotation and (ii) align the second axis of rotation substantially perpendicular to the first axis of rotation.

Example 3 includes any preceding clause(s) of the steering apparatus of examples 1-2, wherein gear teeth of the second gear are distributed about a circumference of the second gear, and wherein a position of the second pinion relative to the second gear is adjustable to enable the second pinion to engage the gear teeth at different locations about the circumference.

Example 4 includes any preceding clause(s) of the steering apparatus of examples 1-3, wherein the gear teeth are first gear teeth, wherein the circumference is a first circumference, wherein second gear teeth of the first gear are distributed about a second circumference of the first gear, and wherein a position of the first pinion relative to the first gear is adjustable to enable engagement with the second gear teeth at different locations about the second circumference.

Example 5 includes any preceding clause(s) of the steering apparatus of examples 1-4, wherein a position of the second pinion is configurable to engage the gear teeth at every location about the circumference.

Example 6 includes any preceding clause(s) of the steering apparatus of examples 1-5, wherein the gear teeth of the second gear face away from the worm gear.

Example 7 includes any preceding clause(s) of the steering apparatus of examples 1-6, wherein gear teeth of the second gear are positioned along a geometric plane that does not intersect the worm gear.

Example 8 includes any preceding clause(s) of the steering apparatus of examples 1-7, wherein the geometric plane is a first geometric plane, wherein the engagement between the second pinion and the second gear is aligned along a second geometric plane that intersects the worm gear.

Example 9 includes any preceding clause(s) of the steering apparatus of examples 1-8, wherein the first gear and the worm gear are aligned along a first axis of rotation, the motor and the second pinion are aligned along a second axis of rotation, the first pinion and the second gear are aligned along a third axis of rotation substantially perpendicular to the first axis of rotation and the second axis of rotation.

Example 10 includes a steering apparatus comprising a worm gear, a ball nut positioned around a portion of the worm gear, a sector gear engaged with the ball nut, the sector gear aligned along a first rotational axis, a first gear fixed to the worm gear, a second gear engaged with the first gear, a third gear fixed to the second gear, the third gear and the second gear aligned along a second rotational axis, a position of the second rotational axis relative to the first rotational axis configurable to enable the second rotational axis to be substantially parallel to the first rotational axis, and a motor including a pinion engaged with the third gear.

Example 11 includes any preceding clause(s) of the steering apparatus of examples 1-10, wherein the position of the second rotational axis relative to the first rotational axis is configurable to enable the second rotational axis to be non-parallel to the first rotational axis.

Example 12 includes any preceding clause(s) of the steering apparatus of examples 1-11, wherein the position of the second rotational axis relative to the first rotational axis is configurable to enable the second rotational axis to be substantially perpendicular to the first rotational axis.

Example 13 includes any preceding clause(s) of the steering apparatus of examples 1-12, wherein the first gear and the second gear form a first bevel gear set.

Example 14 includes any preceding clause(s) of the steering apparatus of examples 1-13, wherein the third gear and the pinion form a second bevel gear set.

Example 15 includes any preceding clause(s) of the steering apparatus of examples 1-14, wherein the first gear and the worm gear have a third rotational axis, the motor and the pinion have a fourth rotational axis, the second rotational axis substantially perpendicular to the third rotational axis and the fourth rotational axis.

Example 16 includes any preceding clause(s) of the steering apparatus of examples 1-15, wherein a position of the fourth rotational axis relative to the first rotational axis is movable to a substantially perpendicular position.

Example 17 includes a vehicle steering system comprising a worm gear, a ball nut positioned around a portion of the worm gear, the ball nut to translate as the worm gear rotates, at least two bevel gear sets including a first gear and a motor pinion, the first gear fixed to the worm gear, the at least two bevel gear sets to transfer rotation of the motor pinion to rotation of the worm gear, and a sector gear engaged with the ball nut, the sector gear to rotate as the ball nut translates.

Example 18 includes any preceding clause(s) of the vehicle steering system of examples 1-17, wherein the at least two bevel gear sets include a first bevel gear set and a second bevel gear set, the first bevel gear set including the first gear and a second pinion, the second bevel gear set including the motor pinion and a second gear, the second pinion fixedly coupled to the second gear.

Example 19 includes any preceding clause(s) of the vehicle steering system of examples 1-18, wherein the first gear and the worm gear are aligned along a first rotational axis, the second gear and the second pinion are aligned along a second rotational axis, the motor pinion is aligned along a third rotational axis, the second rotational axis substantially perpendicular to the first rotational axis and the third rotational axis.

Example 20 includes any preceding clause(s) of the vehicle steering system of examples 1-19, wherein the sector gear is aligned along a fourth rotational axis, wherein an orientation of the second rotational axis relative to the fourth rotational axis is configurable to more than one orientation including a substantially parallel configuration and a non-parallel configuration.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A steering apparatus comprising:
a worm gear;
a ball nut positioned around a portion of the worm gear;
a first gear fixed to the worm gear;
a second gear fixed to a first pinion, the first pinion engaged with the first gear, the first pinion and the first gear to form a first bevel gear set;
a second pinion fixed to a shaft of a motor, the second pinion engaged with the second gear, the second pinion and the second gear to form a second bevel gear set, the motor to rotate the worm gear to translate the ball nut; and
a sector gear engaged with the ball nut, the sector gear to rotate as the ball nut translates.

2. The steering apparatus of claim 1, wherein the first gear and the worm gear are aligned along a first axis of rotation, wherein the motor and the second pinion are aligned along a second axis of rotation, wherein the position of the second pinion relative to the second gear is configurable to (i) align the second axis of rotation substantially parallel to the first axis of rotation and (ii) align the second axis of rotation substantially perpendicular to the first axis of rotation.

3. The steering apparatus of claim 1, wherein gear teeth of the second gear are distributed about a circumference of the second gear, and wherein a position of the second pinion relative to the second gear is adjustable to enable the second pinion to engage the gear teeth at different locations about the circumference.

4. The steering apparatus of claim 3, wherein the gear teeth are first gear teeth, wherein the circumference is a first circumference, wherein second gear teeth of the first gear are distributed about a second circumference of the first gear, and wherein a position of the first pinion relative to the first gear is adjustable to enable engagement with the second gear teeth at different locations about the second circumference.

5. The steering apparatus of claim 3, wherein a position of the second pinion is configurable to engage the gear teeth at every location about the circumference.

6. The steering apparatus of claim 1, wherein gear teeth of the second gear face away from the worm gear.

7. The steering apparatus of claim 1, wherein gear teeth of the second gear are positioned along a geometric plane that does not intersect the worm gear.

8. The steering apparatus of claim 7, wherein the geometric plane is a first geometric plane, wherein the engagement between the second pinion and the second gear is aligned along a second geometric plane that intersects the worm gear.

9. The steering apparatus of claim 1, wherein the first gear and the worm gear are aligned along a first axis of rotation, the motor and the second pinion are aligned along a second axis of rotation, the first pinion and the second gear are aligned along a third axis of rotation substantially perpendicular to the first axis of rotation and the second axis of rotation.

10. A steering apparatus comprising:
a worm gear;
a ball nut positioned around a portion of the worm gear;
a sector gear engaged with the ball nut, the sector gear aligned along a first rotational axis;
a first gear fixed to the worm gear;
a second gear engaged with the first gear;
a third gear fixed to the second gear, the third gear and the second gear aligned along a second rotational axis, a position of the second rotational axis relative to the first rotational axis configurable to enable the second rotational axis to be substantially parallel to the first rotational axis; and
a motor including a pinion engaged with the third gear.

11. The steering apparatus of claim 10, wherein the position of the second rotational axis relative to the first rotational axis is configurable to enable the second rotational axis to be non-parallel to the first rotational axis.

12. The steering apparatus of claim 11, wherein the position of the second rotational axis relative to the first rotational axis is configurable to enable the second rotational axis to be substantially perpendicular to the first rotational axis.

13. The steering apparatus of claim 10, wherein the first gear and the second gear form a first bevel gear set.

14. The steering apparatus of claim 12, wherein the third gear and the pinion form a second bevel gear set.

15. The steering apparatus of claim 10, wherein the first gear and the worm gear have a third rotational axis, the motor and the pinion have a fourth rotational axis, the second rotational axis substantially perpendicular to the third rotational axis and the fourth rotational axis.

16. The steering apparatus of claim 15, wherein a position of the fourth rotational axis relative to the first rotational axis is movable to a substantially perpendicular position.

17. A vehicle steering system comprising:
a worm gear;
a ball nut positioned around a portion of the worm gear, the ball nut to translate as the worm gear rotates;
at least two bevel gear sets including a first gear and a motor pinion, the first gear fixed to the worm gear, the at least two bevel gear sets to transfer rotation of the motor pinion to rotation of the worm gear; and
a sector gear engaged with the ball nut, the sector gear to rotate as the ball nut translates.

18. The vehicle steering system of claim 17, wherein the at least two bevel gear sets include a first bevel gear set and a second bevel gear set, the first bevel gear set including the first gear and a second pinion, the second bevel gear set including the motor pinion and a second gear, the second pinion fixedly coupled to the second gear.

19. The vehicle steering system of claim 18, wherein the first gear and the worm gear are aligned along a first rotational axis, the second gear and the second pinion are aligned along a second rotational axis, the motor pinion is aligned along a third rotational axis, the second rotational axis substantially perpendicular to the first rotational axis and the third rotational axis.

20. The vehicle steering system of claim 19, wherein the sector gear is aligned along a fourth rotational axis, wherein an orientation of the second rotational axis relative to the fourth rotational axis is configurable to more than one orientation including a substantially parallel configuration and a non-parallel configuration.
